(19) United States
(12) Patent Application Publication
(10) Pub. No.: US 2025/0050878 A1
(43) Pub. Date: Feb. 13, 2025

(54) Device And Method For Controlling Autonomous Driving

(71) Applicants: Hyundai Motor Company, Seoul (KR); Kia Corporation, Seoul (KR)

(72) Inventors: Jeong Ki Hong, Seongnam-Si (KR); Kyung Joo Bang, Hwaseong-Si (KR); Jae Woong Hwang, Seoul (KR); Dong Hyuk Kim, Hanam-si (KR); Il Hwan Kim, Hwaseong-Si (KR)

(21) Appl. No.: 18/514,052

(22) Filed: Nov. 20, 2023

(30) Foreign Application Priority Data
Aug. 10, 2023 (KR) 10-2023-0104997

(51) Int. Cl. B60W 30/14; B60W 30/16; B60W 40/105; B60W 60/00

(52) U.S. Cl. CPC B60W 30/146; B60W 30/16; B60W 40/105; B60W 60/001; B60W 2554/802

(57) ABSTRACT

A device for controlling autonomous driving is introduced. A device may comprise a sensor, a memory storing instructions, and a controller operatively connected to the sensor and the memory, wherein the instructions, when executed by the controller, may cause the device to detect, based on the sensor, information associated with at least one of a first vehicle or a second vehicle, determine at least one of whether a distance between the first vehicle and the second vehicle satisfies a distance condition, or whether a travel speed of the first vehicle satisfies a speed condition; and control the first vehicle based on at least some of the information and neither the distance condition nor the speed condition being satisfied, by causing a first deceleration, or based on at least one of the distance condition or the speed condition being satisfied, by causing a second deceleration greater than the first deceleration.

### CROSS-REFERENCE TO RELATED APPLICATION

This application claims the benefit of priority to Korean Patent Application No. 10-2023-0104997, filed in the Korean Intellectual Property Office on Aug. 10, 2023, the entire contents of which are incorporated herein by reference.

### TECHNICAL FIELD

The present disclosure relates to a device and a method for controlling autonomous driving, and more specifically, to a technology of adaptively performing stopping control of a host vehicle based on an inter-vehicle distance and/or a travel speed.

### BACKGROUND

As autonomous vehicles gradually spread, various technologies related to autonomous driving may be applicable. The autonomous driving may be classified into partial automation, conditional automation, high automation, and/or full automation depending on a control level thereof.

In one example, among autonomous driving control functions, various types of control algorithms (or functions) for travel control of a host vehicle may be used.

For example, an autonomous driving control device may identify a deceleration for stopping control of the host vehicle based on at least one of information on a surrounding object (e.g., a front vehicle) of the host vehicle (e.g., an inter-vehicle distance between the front vehicle and the host vehicle), travel information of the host vehicle (e.g., a travel speed), or a relative speed between the surrounding object and the host vehicle, or any combination thereof.

For example, the autonomous driving control device may use various control devices (e.g., at least one of an electronic braking system (EBS), an electronic stability control (ESC), or an electric parking brake (EPB), or any combination thereof) for the stopping control (or deceleration control).

As an example, the EBS may include an electronically controlled compressed air brake. The EBS may perform a function related to at least one of electronically controlled brake, integrated coupling force control, braking control based on an anti-lock braking system (ABS), oscillation control based on a traction control system (TCS), track stabilization using an electronic stability program (ESP), or adaptive cruise control (ACC), or any combination thereof.

As an example, when receiving a stop signal from the autonomous driving control device, the ESC may perform stopping control with continuity (e.g., without any discomfort to a user) until it is determined that the host vehicle is in a stopped state based on the travel speed of the host vehicle.

As an example, when receiving the stop signal from the autonomous driving control device, the EPB may perform stopped state maintenance control to maintain the completely stopped state after determining that the host vehicle is in the stopped state based on the travel speed of the host vehicle.

However, when performing the deceleration control during travel of the host vehicle, the more the host vehicle reaches a stopping distance determined by the autonomous driving control device as a target, errors in the inter-vehicle distance or the relative speed between the host vehicle and the surrounding object, the travel speed, and the like decrease, so that there may be a problem in which a deceleration control amount for the deceleration control converges to 0. Because of such problem, it may be difficult to completely stop the host vehicle. Therefore, the autonomous driving control device may perform a function of realizing the completely stopped state and also maintaining the stopped state by transmitting a separate control signal (e.g., a stop flag stop signal) to a separate controller.

### SUMMARY

According to the present disclosure, a device may comprise: a sensor; a memory configured to store instructions; and a controller operatively connected to the sensor and the memory, wherein the instructions, when executed by the controller, may cause the device to: detect, based on the sensor, information associated with at least one of a first vehicle or a second vehicle; determine at least one of: whether a distance between the first vehicle and the second vehicle satisfies a distance condition, or whether a travel speed of the first vehicle satisfies a speed condition; and control the first vehicle: based on at least some of the information and neither the distance condition nor the speed condition being satisfied, by causing a first deceleration; or based on at least one of the distance condition or the speed condition being satisfied, by causing a second deceleration greater than the first deceleration.

The device, wherein the instructions, when executed by the controller, may cause the device to: determine, based on the distance being smaller than a threshold distance, a third deceleration greater than the first deceleration; and control the first vehicle by causing the third deceleration.

The device, wherein the instructions, when executed by the controller, may cause the device to: control the first vehicle to change, over a time period, from the first deceleration to the third deceleration based on a slope.

The device, wherein the instructions, when executed by the controller, may cause the device to: determine, based on the travel speed being lower than a threshold speed, a third deceleration greater than the first deceleration; and control the first vehicle by causing the third deceleration.

The device, wherein the instructions, when executed by the controller, may cause the device to: control the first vehicle to change, over a time period, from the first deceleration to the third deceleration based on a slope.

The device, wherein the instructions, when executed by the controller, may cause the device to: control the first vehicle to change, over a time period, from the first deceleration to a third deceleration based on a first slope and the distance being smaller than a threshold distance; and control the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

The device, wherein the instructions, when executed by the controller, may cause the device to: maintain a stopped state of the first vehicle based on a stopping deceleration greater than the first deceleration and the first vehicle being stopped based on the travel speed.

The device, wherein the instructions, when executed by the controller, may cause the device to: maintain the stopped state of the first vehicle for a time period starting from a time point at which a situation requiring termination of an autonomous driving control of the first vehicle is determined based on the information; and terminate the autonomous driving control of the first vehicle after the time period elapses.

According to the present disclosure, a method may comprise: detecting, by a controller and based on a sensor, information associated with at least one of a first vehicle or a second vehicle; determining at least one of: whether a distance between the first vehicle and the second vehicle satisfies a distance condition, or whether a travel speed of the first vehicle satisfies a speed condition; and controlling the first vehicle: based on at least some of the information and based on neither the distance condition nor the speed condition being satisfied, by causing a first deceleration; or based on at least one of the distance condition or the speed condition being satisfied, by causing a second deceleration greater than the first deceleration.

The method, may further comprise: determining, based on the distance being smaller than a threshold distance, a third deceleration greater than the first deceleration; and controlling the first vehicle by causing the third deceleration.

The method, wherein the controlling the first vehicle comprises controlling the first vehicle to change, over a time period, from the first deceleration to the third deceleration based on a slope.

The method, may further comprise: determining, based on the travel speed being lower than a threshold speed, a third deceleration greater than the first deceleration; and controlling the first vehicle by causing the third deceleration.

The method, wherein the controlling the first vehicle comprises controlling the first vehicle to change, over a time period, from the first deceleration to the third deceleration based on a slope.

The method, wherein the controlling the first vehicle comprises: controlling the first vehicle to change, over a time period, from the first deceleration to a third deceleration based on a first slope and the distance being smaller than a threshold distance; and controlling the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

The method, may further comprise: maintaining, by the controller, a stopped state of the first vehicle for a time period starting from a time point at which a situation requiring termination an autonomous driving control of the first vehicle is determined based on the information; and terminating, by the controller, the autonomous driving control of the first vehicle after the time period elapses.

According to the present disclosure, a non-transitory computer-readable recording medium storing a program, when executed, may cause a controller to perform: detecting, based on a sensor, information associated at least one of a first vehicle or a second vehicle; determining at least one of: whether a distance between the first vehicle and the second vehicle satisfies a distance condition, or whether a travel speed of the first vehicle satisfies a speed condition; and controlling the first vehicle: based on at least some of the information and neither the distance condition nor the speed condition being satisfied, by causing a first deceleration; or based on at least one of the distance condition or the speed condition being satisfied, by causing a second deceleration being greater than the first deceleration.

The non-transitory computer-readable recording medium, wherein the program, when executed, may cause the controller to perform: determining, based on the distance being smaller than a threshold distance, a third deceleration greater than the first deceleration; and controlling the first vehicle by causing the third deceleration.

The non-transitory computer-readable recording medium, wherein the program, when executed, may cause the controller to perform: determining, based on the travel speed being lower than a threshold speed, a third deceleration greater than the first deceleration; and controlling the first vehicle by causing the third deceleration.

The non-transitory computer-readable recording medium, wherein the program, when executed, may cause the controller to perform: controlling the first vehicle to change, over a time period, from the first deceleration to a third deceleration based on a first slope and the distance being smaller than a threshold distance; and controlling the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

The non-transitory computer-readable recording medium, wherein the program, when executed, may cause the controller to perform: maintaining a stopped state of the first vehicle for a time period starting from a time point at which a situation requiring termination an autonomous driving control of the first vehicle is determined based on the information; and terminating the autonomous driving control of the first vehicle after the time period elapses.

### BRIEF DESCRIPTION OF THE DRAWINGS

The above and other objects, features and advantages of the present disclosure will be more apparent from the following detailed description taken in conjunction with the accompanying drawings.

FIG. 1 shows an example of components of an autonomous driving control device according to an example of the present disclosure;

FIG. 2 shows an example of components of an autonomous driving control device according to an example of the present disclosure;

FIG. 3 shows an example of a deceleration for stopping control of a host vehicle according to an example of the present disclosure;

FIG. 4 shows an example of an autonomous driving control method according to an example of the present disclosure;

FIG. 5 shows an example of an autonomous driving control method according to an example of the present disclosure;

FIG. 6 shows an example of a signal flow between components used by an autonomous driving control device to perform general stopping control according to an example of the present disclosure;

FIG. 7 shows an example of a signal flow between components used by an autonomous driving control device to perform stopping control based on a first required deceleration according to an example of the present disclosure;

FIG. 8 shows an example of a signal flow between components used by an autonomous driving control device to perform stopping control based on a second required deceleration according to an example of the present disclosure;

FIG. 9 shows an example of an autonomous driving control method according to an example of the present disclosure; and

FIG. 10 shows an example of a computing system related to an autonomous driving control method according to an example of the present disclosure.

In relation to the description of the drawings, the same or similar reference numerals may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even if they are displayed on other drawings. Further, in describing the example of the present disclosure, a detailed description of the related known configuration or function will be omitted if it is determined that it interferes with the understanding of the example of the present disclosure.

In describing the components of the example according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

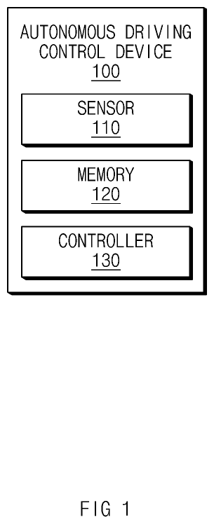

Hereinafter, examples of the present disclosure will be described in detail with reference to FIGS. 1 to 6.

FIG. 1 shows an example of components of an autonomous driving control device according to an example of the present disclosure.

According to one example, an autonomous driving control device 100 may include at least one of a sensor 110, a memory 120, or a controller 130, or any combination thereof. The configuration of the autonomous driving control device 100 shown in FIG. 1 is an example and examples of the present disclosure are not limited thereto. For example, the autonomous driving control device 100 may further include components not shown in FIG. 1 (e.g., at least one of an interface, a communication device, or a display, or any combination thereof).

According to one example, the sensor 110 may acquire (or identify) various information used regarding travel of a host vehicle.

For example, the sensor 110 may include at least one sensor including at least one of a camera, a radar, or a LiDAR, or any combination thereof.

For example, the sensor 110 may identify information on travel of at least one other vehicle traveling adjacent to the host vehicle.

As an example, the sensor 110 may identify information on travel of a front vehicle traveling in front of the host vehicle. For example, the sensor 110 may identify front vehicle information including at least one of an inter-vehicle distance, a relative speed, and a relative distance between the host vehicle and the front vehicle, or an acceleration of the front vehicle, or any combination thereof.

As an example, the sensor 110 may identify information on the host vehicle. For example, the sensor 110 may identify a real-time travel speed of the host vehicle. For example, the sensor 110 may identify at least one of a real-time deceleration amount or a deceleration slope of the host vehicle, or any combination thereof.

According to one example, the memory 120 may store instructions or data. For example, the memory 120 may store one or more instructions that, when executed by the controller 130, cause the autonomous driving control device 100 to perform various operations.

For example, the memory 120 may be implemented as one chipset with the controller 130. The controller 130 may include at least one of a communication processor or a modem.

For example, the memory 120 may store various information related to the autonomous driving control device 100. As an example, the memory 120 may store information on an operation history of the controller 130. As an example, the memory 120 may store information related to states and/or operation of the components (e.g., at least one of an engine control unit (ECU), the sensor 110, or the controller 130, or any combination thereof) of the host vehicle.

According to one example, the controller 130 may be operatively connected to the sensor 110 and/or the memory 120. For example, the controller 130 may control operation of the sensor 110 and/or the memory 120.

For example, the controller 130 may identify information on at least one of the host vehicle or the front vehicle, or any combination thereof using the sensor 110.

As an example, the controller 130 may identify at least one of the travel speed, an acceleration, the real-time deceleration amount, or the deceleration slope of the host vehicle, or any combination thereof using the sensor 110.

As an example, the controller 130 may identify at least one of a travel speed, a real-time deceleration amount, a deceleration slope, or the inter-vehicle distance between the host vehicle and the front vehicle of the front vehicle existing in front of the host vehicle, or any combination thereof using the sensor 110.

For example, the controller 130 may identify a first deceleration for stopping control of the host vehicle based on at least some of the information identified using the sensor 110.

As an example, the controller 130 may activate the stopping control of the host vehicle based on at least some of the information. In this regard, the controller 130 may identify the first deceleration as a control amount for the stopping control.

As an example, the controller 130 may perform the stopping control on the host vehicle based on the first deceleration. For example, the controller 130 may lower the travel speed of the host vehicle based on the first deceleration.

For example, the controller 130 may determine whether at least one of the inter-vehicle distance or the travel speed, or any combination thereof satisfies a specified condition while performing the stopping control based on the first deceleration.

As an example, if identifying that the inter-vehicle distance between the host vehicle and the front vehicle is smaller than a specified distance while performing the stopping control, the controller 130 may determine that the inter-vehicle distance satisfies the specified condition.

As an example, if identifying that the travel speed of the host vehicle is lower than a specified speed while performing the stopping control, the controller 130 may determine that the travel speed satisfies the specified condition.

For example, if at least one of the inter-vehicle distance or the travel speed, or any combination thereof satisfies the specified condition, the controller 130 may perform the stopping control on the host vehicle based on a deceleration greater than the first deceleration.

As an example, if identifying that the inter-vehicle distance is smaller than the specified distance (e.g., 6 m), the controller 130 may continue to perform the stopping control on the host vehicle based on a first required deceleration greater than the first deceleration. In this regard, the controller 130 may gradually increase the control amount for the stopping control from the first deceleration to the first required deceleration based on a first slope. In other words, the controller 130 may increase the deceleration for the stopping control from the first deceleration to the first required deceleration based on the first slope.

As an example, if identifying that the travel speed of the host vehicle is lower than the specified speed (e.g., 1 km/h), the controller 130 may continue to perform the stopping control on the host vehicle based on a second required deceleration greater than the first deceleration. In this regard, the controller 130 may gradually increase the control amount for the stopping control from the first deceleration to the second required deceleration based on a second slope. In other words, the controller 130 may increase the deceleration for the stopping control from the first deceleration to the second required deceleration based on the second slope.

For example, while performing the stopping control on the host vehicle with the first required deceleration, the controller 130 may change the control amount for the stopping control based on the second required deceleration.

As an example, if identifying that the inter-vehicle distance between the host vehicle and the front vehicle is smaller than the specified distance while performing the stopping control on the host vehicle based on the first deceleration, the controller 130 may gradually increase the control amount for the stopping control from the first deceleration to the first required deceleration based on the first slope. In this regard, while increasing the control amount based on the first slope, the controller 130 may identify that the travel speed of the host vehicle is lower than the specified speed at a time point at which the control amount has a first value. In this case, the controller 130 may gradually increase the control amount for the stopping control of the host vehicle from the first value to the second required deceleration based on the second slope.

As an example, the second required deceleration and the second slope may be greater than the first required deceleration and the first slope, respectively.

For example, the controller 130 may monitor the travel speed of the host vehicle in real time. As an example, the controller 130 may identify that the host vehicle is stopped based on the travel speed of the host vehicle. In this case, the controller 130 may maintain the stopped state of the host vehicle based on a stopping deceleration greater than the first deceleration, the first required deceleration, and/or the second required deceleration. In other words, the controller 130 may maintain the stopped state by continuously applying the stopping deceleration while the host vehicle is stopped.

For example, the controller 130 may identify a situation requiring termination of the operation of the autonomous driving control device 100 based on various information on the situation in which the host vehicle is traveling.

As an example, the situation requiring the termination of the operation may include a situation in which the control of the autonomous driving control device 100 (e.g., autonomous driving control) is no longer required or manual control is required. The situation requiring the termination of the operation may, for example, include at least one of a situation in which the user leaves the host vehicle, a situation in which there is no user present in the host vehicle, or a situation in which the host vehicle is expected to collide with an external object (e.g., another vehicle), or any combination thereof.

As an example, when the situation requiring the termination of the operation is identified, the controller 130 may maintain the stopped state of the host vehicle based on the stopping deceleration for a specified time duration (e.g., 10 minutes) from a time point at which the situation is identified, and terminate the operation of the autonomous driving control device 100 after the specified time duration has elapsed.

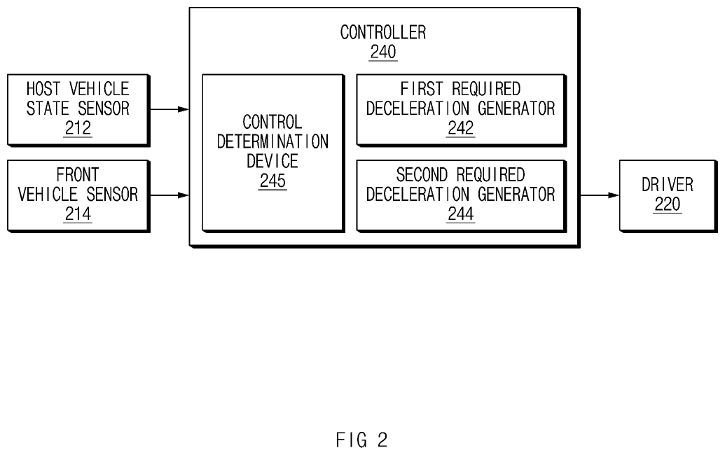

FIG. 2 shows an example of components of an autonomous driving control device according to an example of the present disclosure.

According to one example, an autonomous driving control device (e.g., the autonomous driving control device 100 in FIG. 1) may include at least one of a host vehicle state sensor 212, a front vehicle sensor 214, a driver 220, or a controller 240, or any combination thereof. For example, the controller 240 may include at least one of a first required deceleration generator 242, a second required deceleration generator 244, or a control determination device 245, or any combination thereof.

A structure of the components shown in FIG. 2 is an example, and examples of the present disclosure are not limited thereto. For example, at least some (e.g., the host vehicle state sensor 212 and the front vehicle sensor 214) of the components shown in FIG. 2 may be implemented as a portion of the controller 130 and/or the sensor 110 in FIG. 1 or may be implemented as one chip with the controller 130 and/or the sensor 110. In other words, at least some of operations of at least some of the components to be described later may be performed by the controller 130 and/or the sensor 110 in FIG. 1 (or under control of the controller 130).

For example, the host vehicle state sensor 212 may identify various information on a state of the host vehicle.

As an example, the host vehicle state sensor 212 may identify at least one of the real-time travel speed, the real-time deceleration amount, or the deceleration slope of the host vehicle, or any combination thereof.

For example, the front vehicle sensor 214 may identify various information on the front vehicle.

As an example, the front vehicle sensor 214 may identify the front vehicle information including at least one of the inter-vehicle distance, the relative speed, and the relative distance between the host vehicle and the front vehicle, or the acceleration of the front vehicle, or any combination thereof.

For example, the controller 240 may identify the deceleration for the stopping control of the host vehicle based on the information identified by the host vehicle state sensor 212 and the front vehicle sensor 214.

As an example, the controller 240 may generate a required deceleration for the stopping control of the host vehicle using the first required deceleration generator 242 and/or the second required deceleration generator 244.

As an example, if at least one of the inter-vehicle distance or the travel speed, or any combination thereof satisfies the specified condition, the controller 240 may apply one of the first required deceleration and the second required deceleration for the stopping control of the host vehicle via determination of the control determination device 245.

As an example, if identifying that the inter-vehicle distance between the host vehicle and the front vehicle is smaller than the specified distance, the controller 240 may transmit the first required deceleration to the driver 220 to continue performing the stopping control based on the first required deceleration greater than the first deceleration that was applied for the initial stopping control.

In this case, the controller 240 may perform the stopping control of the host vehicle via the driver 220 while gradually increasing the control amount for the stopping control of the host vehicle from the first deceleration to the first required deceleration based on the first slope.

As an example, if identifying that the travel speed of the host vehicle is lower than the specified speed, the controller 240 may transmit the second required deceleration to the driver 220 to continue performing the stopping control based on the second required deceleration greater than the first required deceleration.

In this case, the controller 240 may perform the stopping control of the host vehicle via the driver 220 while gradually increasing the control amount for the stopping control of the host vehicle from the first deceleration to the second required deceleration based on the second slope.

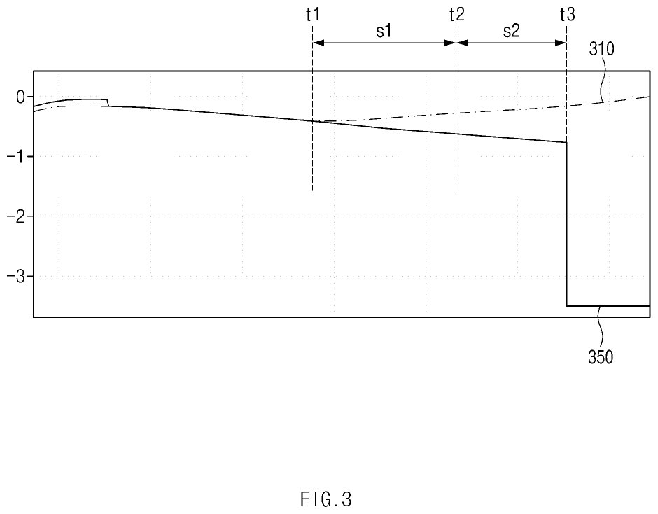

FIG. 3 shows an example of a deceleration for stopping control of a host vehicle according to an example of the present disclosure.

According to one example, an autonomous driving control device (e.g., the autonomous driving control device 100 in FIG. 1) may adjust the required deceleration for the stopping control of the host vehicle based on whether at least one of the inter-vehicle distance between the host vehicle and the front vehicle or the travel speed of the host vehicle, or any combination thereof satisfies the specified condition.

For example, a graph according to reference numeral 310 may be the required deceleration for the stopping control of the host vehicle identified by the autonomous driving control device based on field oriented control (FOC).

For example, before a first time point t1, the autonomous driving control device may apply the required deceleration based on the graph according to reference numeral 310 to the driver of the host vehicle via a method according to the prior art.

For example, at the first time point t1, the autonomous driving control device may identify that the inter-vehicle distance between the host vehicle and the front vehicle is smaller than the specified distance. Accordingly, the autonomous driving control device may apply the first required deceleration based on a graph according to reference numeral 350 to the driver of the host vehicle from the first time point t1 to a second time point t2. In particular, the autonomous driving control device may perform the stopping control based on the first required deceleration based on the first deceleration used immediately before the first time point t1 such that the user does not experience discomfort resulted from the stopping control when performing the stopping control via the required deceleration at the first time point t1.

As an example, the autonomous driving control device may gradually increase the control amount for the stopping control of the host vehicle from the first time point t1 to the second time point t2 from the first deceleration to the first required deceleration based on the first slope. The graph according to the reference numeral 350 shows a y value (e.g., the required deceleration) gradually decreasing, but this is a drawing showing the deceleration that lowers the travel speed as a negative value for convenience, and the above description may be referred to as illustrating an absolute value of the first required deceleration.

As an example, the specified distance may be 6 m, but this may be a setting value that may be changed by manipulation by the user and/or a developer.

For example, at the second time point t2, the autonomous driving control device may identify that the travel speed of the host vehicle is lower than the specified speed. Therefore, the autonomous driving control device may apply the first required deceleration based on the graph according to the reference numeral 350 to the driver of the host vehicle from second time point t2 to a third time point t3. In particular, the autonomous driving control device may perform the stopping control based on the second required deceleration based on the first value (e.g., an y value of reference numeral 350 corresponding to t2 in FIG. 3) used immediately before the second time point t2 such that the user does not experience the discomfort resulted from the stopping control when performing the stopping control via the required deceleration at the second time point t2.

As an example, the autonomous driving control device may gradually increase the control amount for the stopping control of the host vehicle from the second time point t2 to the third time point t3 from the first value to the second required deceleration based on the second slope. The graph according to the reference numeral 350 shows the y value (e.g., the required deceleration) gradually decreasing, but this is a drawing showing the deceleration that lowers the travel speed as the negative value for convenience, and the above description may be referred to as illustrating an absolute value of the second required deceleration.

For example, at the third time point t3, the autonomous driving control device may identify that the host vehicle is stopped based on the travel speed of the host vehicle. For example, when identifying that the travel speed of the host vehicle is a specified value (e.g., 0 km/h), the autonomous driving control device may identify that the host vehicle is completely stopped.

In this case, the autonomous driving control device may maintain the completely stopped state of the host vehicle by applying the stopping deceleration (e.g., 3.5 m/s²) greater than the first deceleration to the host vehicle (or the driver for the travel of the host vehicle).

As an example, when identifying the situation requiring the termination of the operation of the autonomous driving control device, the autonomous driving control device may maintain the stopped state of the host vehicle based on the stopping deceleration for the specified time duration (e.g., 10 minutes) from the time point at which the situation is identified, and terminate the operation of the autonomous driving control device after the specified time duration has elapsed. The situation requiring the termination of the operation may, for example, include at least one of the situation in which the user leaves the host vehicle, the situation in which there is no user present in the host vehicle, or the situation in which the host vehicle is expected to collide with the external object (e.g., another vehicle), or any combination thereof.

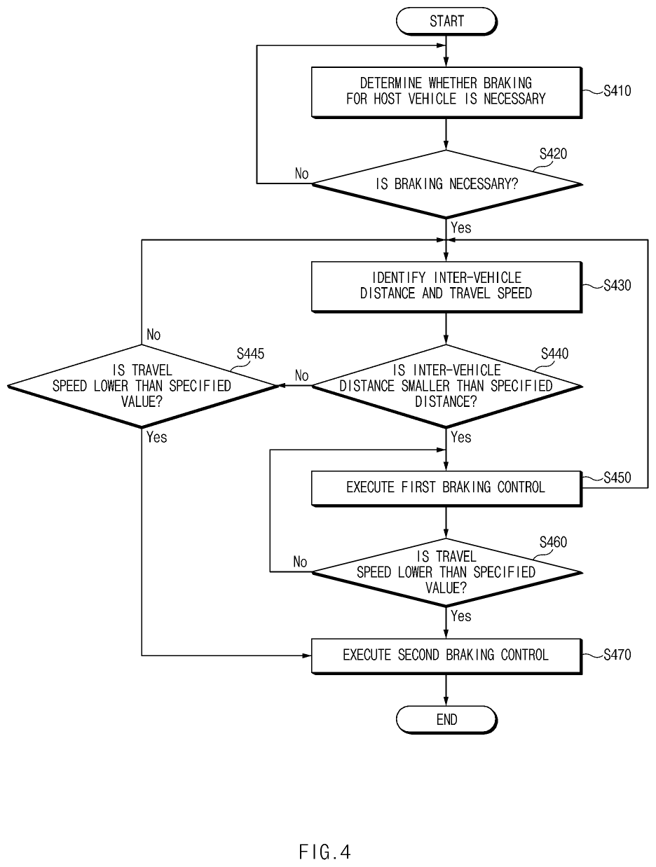

FIG. 4 shows an example of an autonomous driving control method according to an example of the present disclosure.

According to one example, an autonomous driving control device (e.g., the autonomous driving control device in FIG. 1) may perform operations disclosed in FIG. 4. For example, at least some of the components (e.g., the sensor 110, the memory 120, and/or the controller 130 in FIG. 1) included in the autonomous driving control device may be set to perform the operations in FIG. 4.

In the following example, operations S410 to S470 may be performed sequentially, but are not necessarily performed sequentially. For example, an order of each operation may be changed, and at least two operations may be performed in parallel with each other. Additionally, content that corresponds to or redundant to the content described above with respect to FIG. 4 may be briefly described or omitted.

According to one example, the autonomous driving control device may determine whether braking for the host vehicle is necessary (S410).

For example, the autonomous driving control device may determine whether it is necessary to lower the travel speed of the host vehicle based on a travel path, the travel speed, the inter-vehicle distance with the front vehicle, and the like of the host vehicle.

According to one example, the autonomous driving control device may determine whether the braking is necessary (S420).

For example, if it is identified that the travel speed of the host vehicle needs to be braked (e.g., step S420—Yes), the autonomous driving control device may perform step S430.

For example, if it is identified that there is no need to brake the travel speed of the host vehicle (e.g., step S420—No), the autonomous driving control device may repeat step S410.

According to one example, the autonomous driving control device may identify the inter-vehicle distance and the travel speed (S430).

For example, the autonomous driving control device may continuously identify the inter-vehicle distance with the front vehicle and/or the real-time travel speed of the host vehicle while performing deceleration control for the host vehicle based on the first deceleration.

According to one example, the autonomous driving control device may determine whether the inter-vehicle distance between the host vehicle and the front vehicle is smaller than the specified distance (S440).

For example, the inter-vehicle distance may be 6 m, but this is an example and the examples of the present disclosure are not limited thereto.

For example, if the inter-vehicle distance is smaller than the specified distance (e.g., step S440 Yes), the autonomous driving control device may perform step S450.

For example, if the inter-vehicle distance is equal to or greater than the specified distance (e.g., step S440—No), the autonomous driving control device may perform step S445.

According to one example, the autonomous driving control device may determine whether the travel speed of the host vehicle is lower than the specified value (or the specified speed) (S445).

For example, the specified value may be 1 km/h, but this is an example and the examples of the present disclosure are not limited thereto.

For example, if the travel speed is lower than the specified value (e.g., step S445—Yes), the autonomous driving control device may perform step S470.

For example, if the travel speed is equal to or higher than the specified value (e.g., step S445—No), the autonomous driving control device may repeat step S430.

According to one example, the autonomous driving control device may execute first braking control (S450).

For example, if identifying that the inter-vehicle distance between the host vehicle and the front vehicle is smaller than the specified distance, the autonomous driving control device may activate the first braking control that continues to perform the stopping control based on the first required deceleration greater than the first deceleration.

For example, the autonomous driving control device may gradually increase the control amount for the stopping control of the host vehicle from the first deceleration to the first required deceleration based on the first slope.

According to one example, the autonomous driving control device may determine whether the travel speed is lower than the specified value (S460).

For example, if the travel speed is smaller than the specified value (e.g., step S460—Yes), the autonomous driving control device may perform step S470.

For example, if the travel speed is equal to or greater than the specified value (e.g., step S460—No), the autonomous driving control device may repeatedly perform step S450.

According to one example, the autonomous driving control device may execute second braking control (S470).

For example, if identifying that the travel speed is lower than the specified speed, the autonomous driving control device may gradually increase the control amount for the stopping control of the host vehicle from the first deceleration to the second required deceleration based on the second slope.

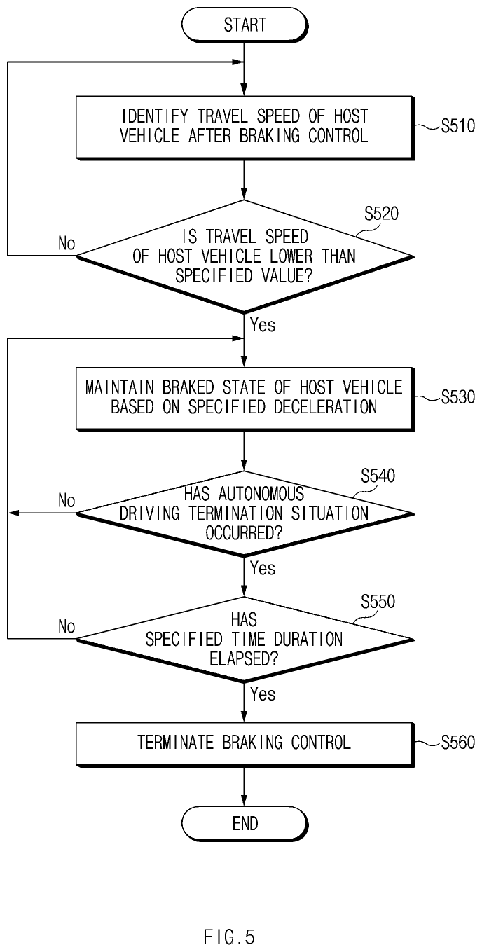

FIG. 5 shows an example of an autonomous driving control method according to an example of the present disclosure.

According to one example, an autonomous driving control device (e.g., the autonomous driving control device in FIG. 1) may perform operations disclosed in FIG. 5. For example, at least some of the components (e.g., the sensor 110, the memory 120, and/or the controller 130 in FIG. 1) included in the autonomous driving control device may be set to perform the operations in FIG. 5.

In the following example, operations S510 to S560 may be performed sequentially, but are not necessarily performed sequentially. For example, an order of each operation may be changed, and at least two operations may be performed in parallel with each content that other. Additionally, corresponds to or redundant to the content described above with respect to FIG. 5 may be briefly described or omitted.

According to one example, the autonomous driving control device may identify the travel speed of the host vehicle after the braking control (or the stopping control) (S510).

For example, the autonomous driving control device may monitor the travel speed of the host vehicle in real time while performing the braking control based on at least one of the first deceleration, the first required deceleration, or the second required deceleration, or any combination thereof.

According example, the autonomous driving control device may determine whether the travel speed of the host vehicle is equal to or smaller than the specified value (S520).

For example, the specified value may be 0 km/s, but this is an example and the examples of the present disclosure are not limited thereto.

For example, if the travel speed of the host vehicle is equal to or lower than the specified value (e.g., step S520—Yes), the autonomous driving control device may perform step S530.

For example, if the travel speed of the host vehicle exceeds the specified value (e.g., step S520—No), the autonomous driving control device may repeat step S510.

According to one example, the autonomous driving control device may maintain the braked state (or the stopped state) of the host vehicle based on a specified deceleration (S530).

For example, the specified deceleration may be −3.5 m/s², but this is an example and the examples of the present disclosure are not limited thereto.

According to one example, the autonomous driving control device may determine whether an autonomous driving termination situation has occurred (S540).

For example, the autonomous driving termination situation (or an operation termination required situation) may include at least one of the situation in which the user leaves the host vehicle, the situation in which there is no user present in the host vehicle, or the situation in which the host vehicle is expected to collide with the external object (e.g., another vehicle), or any combination thereof.

For example, if the autonomous driving termination situation occurs (e.g., step S540 Yes), the autonomous driving control device may perform step S550.

For example, if the autonomous driving termination situation does not occur (e.g., step S540—No), the autonomous driving control device may repeat step S530.

According to one example, the autonomous driving control device may determine whether the specified time duration has elapsed (S550).

For example, the specified time duration may be 10 minutes, but this is an example and the examples of the present disclosure are not limited thereto.

For example, if the specified time duration has elapsed (e.g., step S550—Yes), the autonomous driving control device may perform step S560.

For example, if the specified time duration has not elapsed (e.g., step S550—No), the autonomous driving control device may repeatedly perform step S530.

According to one example, the autonomous driving control device may terminate the braking control (S560).

For example, the autonomous driving control device may terminate all of the autonomous driving control for the host vehicle, including the braking control, and terminate the operation of the autonomous driving control device.

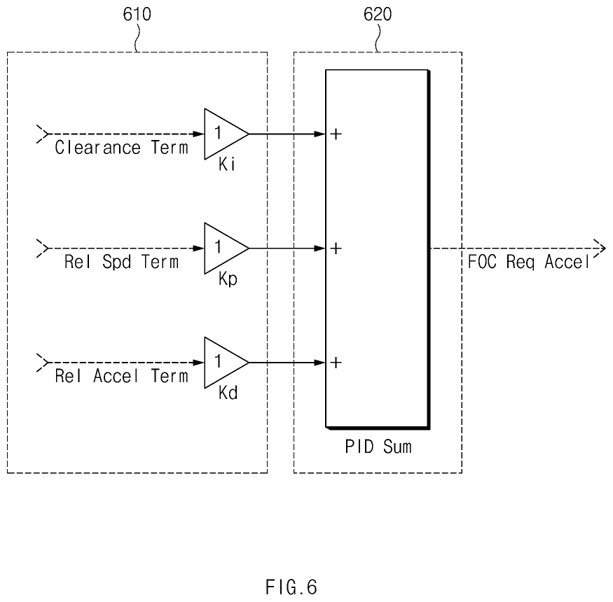

FIG. 6 shows an example of a signal flow between components used by an autonomous driving control device to perform general stopping control according to an example of the present disclosure.

Referring to reference numeral 610, according to one example, an autonomous driving control device (e.g., the autonomous driving control device 100 in FIG. 1) may determine that the braking of the host vehicle is required while performing the autonomous driving control of the host vehicle.

For example, the autonomous driving control device may calculate the first deceleration based on at least one of the inter-vehicle distance (Clearance Term) between the host vehicle and another vehicle (e.g., the front vehicle), the real-time travel speed (Rel Spd Term), or a real-time acceleration (Rel Accel Term), or any combination thereof.

With reference to reference numeral 620, according to one example, the autonomous driving control device may identify the first deceleration (FOC Req Accel) by performing PID control (PID Sum) based on values obtained by multiplying the inter-vehicle distance (the Clearance Term), the real-time travel speed (the Rel Spd Term), and the real-time acceleration (the Rel Accel Term) by gain values Ki, Kp, and Kd, respectively.

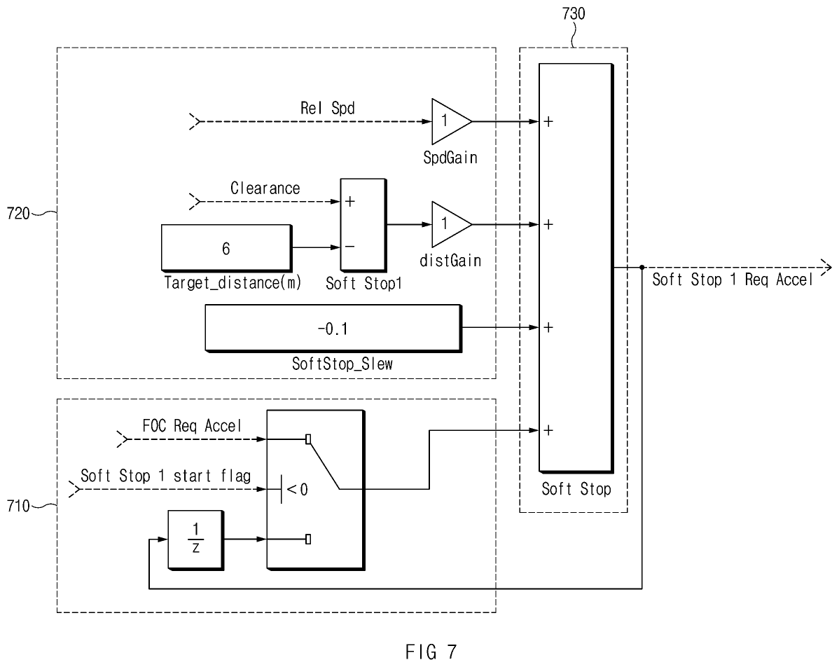

FIG. 7 shows an example of a signal flow between components used by an autonomous driving control device to perform stopping control based on a first required deceleration according to an example of the present disclosure.

Referring to reference numeral 710, according to one example, an autonomous driving control device (e.g., the autonomous driving control device 100 in FIG. 1) may determine that additional braking for the host vehicle is required while performing the braking control with the first deceleration for the host vehicle.

For example, the autonomous driving control device may perform the braking control using the first deceleration (the FOC Req Accel) as shown in FIG. 7 if a first braking control activation signal (e.g., Soft Stop 1 start flag) is smaller than 0 (e.g., first braking control OFF).

For example, the autonomous driving control device may connect a soft stop circuit according to reference numeral 730 to a lower side using a switch element according to reference numeral 710 if the first braking control activation signal (e.g., the Soft Stop 1 start flag) is greater than 0 (e.g., first braking control ON). Accordingly, the autonomous driving control device may output a value obtained by multiplying the first required deceleration (the Soft Stop 1 Req Accel) by a feedback gain 1/z.

For example, the first braking control activation signal may change in a form of a trigger (e.g., 0->1->0) at a time point at which the autonomous driving control device starts activating the first braking control (or a time point of activating the state of Soft Stop 1). The autonomous driving control device may control the host vehicle based on an overridden deceleration (e.g., the first required deceleration) starting from the initially identified deceleration (e.g., the first deceleration), based on identifying that the first braking control activation signal changes in the above-described form.

With reference to reference numeral 720, according to one example, the autonomous driving control device may identify the first required deceleration using at least one of the real-time travel speed (Rel Spd), the inter-vehicle distance (Clearance), the specified distance (Target_distance (m)) (e.g., 6 m), or a first slew rate (Soft Stop1_Slew) (e.g., −0.1), or any combination thereof.

Referring to reference numeral 730, according to one example, if the inter-vehicle distance (Clearance) is smaller than the specified distance (Target_distance (m)), the autonomous driving control device may identify the first required deceleration (Soft Stop 1 Req Accel) based on values obtained by multiplying the real-time travel speed (Rel Spd), and the inter-vehicle distance (Clearance) and the specified distance (Target_distance (m)) by gain values spdGain and distGain, respectively, the first slew rate (Soft Stop1_Slew), and the value obtained by multiplying the first required deceleration (Soft Stop 1 Req Accel) by the feedback gain 1/z.

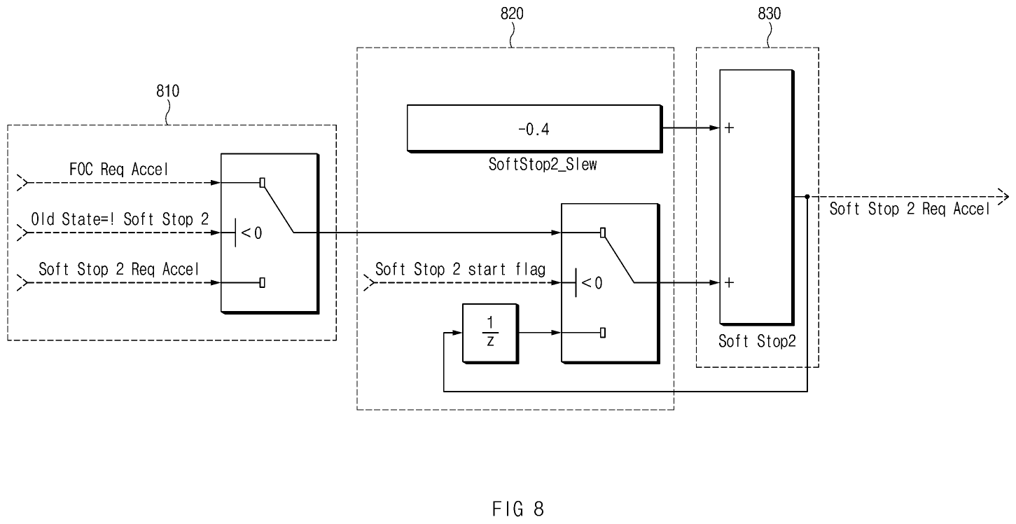

FIG. 8 shows an example of a signal flow between components used by an autonomous driving control device to perform stopping control based on a second required deceleration according to an example of the present disclosure.

Referring to reference numeral 810, according to one example, an autonomous driving control device (e.g., the autonomous driving control device 100 in FIG. 1) may determine whether the second braking control (or second stopping control) based on the second required deceleration has been being performed for the host vehicle.

For example, the autonomous driving control device may output the first deceleration (FOC Req Accel) as shown in FIG. 8 if an existing braking control state signal (e.g., Old State=! Soft Stop 2) is smaller than 0.

For example, if the existing braking control state signal (e.g., Old State=! Soft Stop 2) is greater than 0, the autonomous driving control device may connect a switch circuit according to the reference numeral 820 to a lower side (e.g., Soft Stop 2 Req Accel) using a switch element according to reference numeral 810.

Referring to reference numeral 820, according to one example, the autonomous driving control device may determine that the additional braking for the host vehicle is necessary while performing the braking control with the first deceleration or the first required deceleration for the host vehicle.

For example, the autonomous driving control device may perform the braking control using a signal output from the switch element according to reference numeral 810 as shown in FIG. 8 if a second braking control activation signal (e.g., Soft Stop 2 start flag) is smaller than 0 (e.g., second braking control OFF).

For example, the autonomous driving control device may output a value obtained by multiplying the second required deceleration (Soft Stop 2 Req Accel) output from a Soft Stop circuit according to reference numeral 830 by the feedback gain 1/z to the Soft Stop 2 circuit if the second braking control activation signal (e.g., Soft Stop 2 start flag) is greater than 0 (e.g., second braking control ON).

For example, the second braking control activation signal may change in a form of a trigger (e.g., 0->1->0) at a time point at which the autonomous driving control device starts activating the second braking control (or a time point of activating the state of Soft Stop 2). The autonomous driving control device may control the host vehicle based on an overridden deceleration (e.g., the second required deceleration) starting from the initially identified deceleration (e.g., the second deceleration) or the first required deceleration, based on identifying that the second braking control activation signal changes in the above-described form.

For example, the autonomous driving control device may output a second slew rate (SoftStop2_Slew) (e.g., −0.4) to the Soft Stop 2 circuit according to reference numeral 830.

Referring to reference numeral 830, according to one example, the autonomous driving control device may identify the second required deceleration (Soft Stop 2 Req Accel) based on the second slew rate (Soft Stop2_Slew) and a value obtained by multiplying the second required deceleration (Soft Stop 2 Req Accel) by the feedback gain 1/z if the second braking control activation signal (e.g., Soft Stop 2 start flag) is greater than 0 (e.g., if the travel speed of the host vehicle is lower than the specified speed (e.g., 1 km/h)).

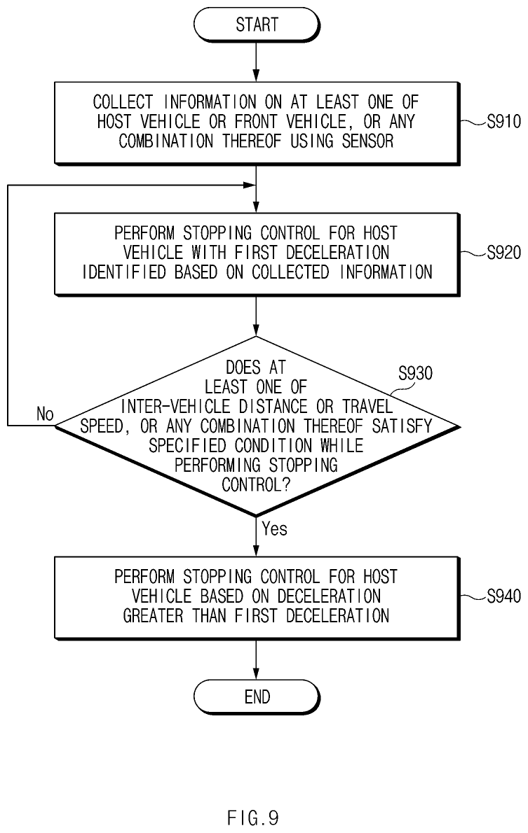

FIG. 9 shows an example of an autonomous driving control method according to example of the present disclosure.

According to one example, an autonomous driving control device (e.g., the autonomous driving control device in FIG. 1) may perform operations disclosed in FIG. 9. For example, at least some of the components (e.g., the sensor 110, the memory 120, and/or the controller 130 in FIG. 1) included in the autonomous driving control device may be set to perform the operations in FIG. 9.

In the following example, operations S910 to S940 may be performed sequentially, but are not necessarily performed sequentially. For example, an order of each operation may be changed, and at least two operations may be performed in parallel with each other. Additionally, content that corresponds to or redundant to the content described above with respect to FIG. 9 may be briefly described or omitted.

According to one example, the autonomous driving control device may collect (or identify) the information on at least one of the host vehicle or the front vehicle, or any combination thereof using the sensor (S910).

According to one example, the autonomous driving control device may perform the stopping control for the host vehicle with the first deceleration identified based on the collected information (S920).

For example, the autonomous driving control device may perform the stopping control for the host vehicle based on the first deceleration, which is the preset deceleration. The first deceleration may be the setting value that may be changed by the user and/or the developer.

According to one example, the autonomous driving control device may determine whether at least one of the inter-vehicle distance or the travel speed, or any combination thereof satisfies the specified condition while performing the stopping control (S930).

For example, the autonomous driving control device may determine whether the inter-vehicle distance is smaller than the specified distance or whether the travel speed is lower than the specified speed, or any combination thereof.

For example, if at least one of the inter-vehicle distance or the travel speed, or any combination thereof satisfies the specified condition (e.g., step S930—Yes), the autonomous driving control device may perform step S940.

For example, if the inter-vehicle distance and the travel speed do not satisfy the specified condition (e.g., step S930—No), the autonomous driving control device may repeat step S920.

According to one example, the autonomous driving control device may perform the stopping control for the host vehicle based on the deceleration greater than the first deceleration (S940).

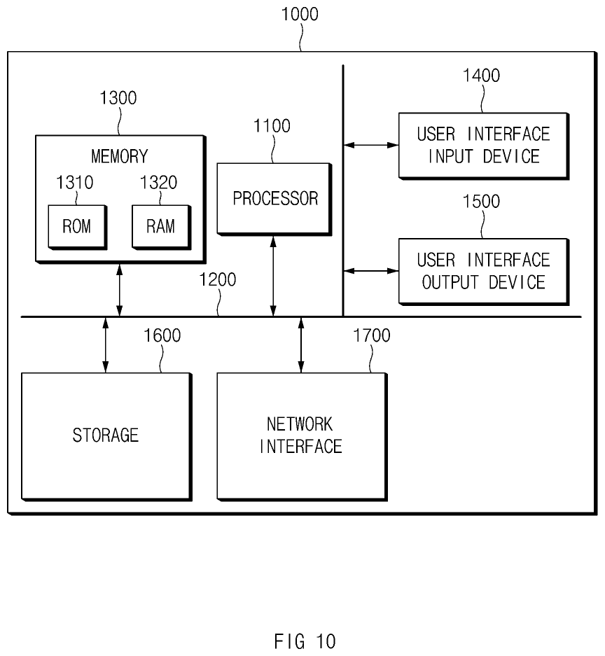

FIG. 10 shows an example of a computing system related to an autonomous driving control method according to an example of the present disclosure.

With reference to FIG. 10, a computing system 1000 related to the autonomous driving control method may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the examples disclosed herein may be embodied directly in hardware or a software module executed by the processor 1100, or in a combination thereof. The software module may reside on a storage medium (e.g., the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The present disclosure has been made to solve the above-mentioned problems occurring in the prior art while advantages achieved by the prior art are maintained intact.

An example of the present disclosure provides an autonomous driving control device that may identify information on at least one of a host vehicle or a front vehicle, or any combination thereof using a sensor, and identify deceleration for stopping control of the host vehicle based on the identified information.

Another example of the present disclosure provides an autonomous driving control device that may perform stopping control for a host vehicle based on a greater deceleration, based on whether at least one of an inter-vehicle distance between the host vehicle and a front vehicle or a travel speed of the host vehicle, or any combination thereof satisfies a specified condition while performing the stopping control.

Another example of the present disclosure provides an autonomous driving control device that, if identifying that an inter-vehicle distance is smaller than a specified distance while performing stopping control, may gradually increase a control amount for the stopping control from a deceleration that has been applied before the identification to a first required deceleration based on a first slope.

Another example of the present disclosure provides an autonomous driving control device that, if identifying that a travel speed of a host vehicle is lower than a specified speed at a time point at which a control amount has a first value while increasing the control amount based on a first slope, may gradually increase the control amount from the first value to a second required deceleration greater than a first required deceleration based on a second slope greater than the first slope.

Another example of the present disclosure provides an autonomous driving control device that, if a host vehicle is in a completely stopped state based on a travel speed of the host vehicle, may maintain the stopped state of the host vehicle based on a stopping deceleration greater than control amounts that have been applied for stopping control.

Another example of the present disclosure provides an autonomous driving control device that may terminate operation thereof after a specified time duration if identifying that a situation that requires termination of autonomous driving control of a host vehicle after the host vehicle is in a completely stopped state based on a travel speed of the host vehicle.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a device for controlling autonomous driving includes a sensor, a memory that stores one or more instructions, and a controller operatively connected to the sensor and the memory. For example, the instructions, when executed by the controller, cause the device to identify information on at least one of a host vehicle or a front vehicle, or any combination using the sensor, perform stopping control for the host vehicle with a first deceleration identified based on at least some of the information, and perform the stopping control for the host vehicle based on a deceleration greater than the first deceleration if at least one of an inter-vehicle distance or a travel speed, any combination satisfies a specified condition while performing the stopping control.

In one implementation, the instructions, when executed by the controller, cause the device to continue to perform the stopping control based on a first required deceleration greater than the first deceleration if identifying that the inter-vehicle distance between the host vehicle and the front vehicle is smaller than a specified distance while performing the stopping control.

In one implementation, the instructions, when executed by the controller, cause the device to gradually increase a control amount for stopping control from the first the deceleration to the f first required deceleration based on a first slope if identifying that the inter-vehicle distance is smaller than the specified distance.

In one implementation, the instructions, when executed by the controller, cause the device to continue to perform the stopping control based on a second required deceleration greater than the first deceleration if identifying that the travel speed of the host vehicle is lower than a specified speed while performing the stopping control.

In one implementation, the instructions, when executed by the controller, cause the device to gradually increase a control amount for the stopping control from the first deceleration to the second required deceleration based on a second slope if identifying that the travel speed is lower than the specified speed.

In one implementation, the instructions, when executed by the controller, cause the device to gradually increase a control amount for the stopping control from the first deceleration to a first required deceleration based on a first slope if identifying that the inter-vehicle distance between the host vehicle and the front vehicle is smaller than a specified distance while performing the stopping control, and gradually increase the control amount from a first value to a second required deceleration greater than the first required deceleration based on a second slope greater than the first slope if identifying that the travel speed of the host vehicle is lower than a specified speed at a time point if the control amount has the first value while increasing the control amount based on the first slope.

In one implementation, the instructions, when executed by the controller, cause the device to maintain a stopped state of the host vehicle based on a stopping deceleration greater than the first deceleration if identifying that the host vehicle is stopped based on the travel speed of the host vehicle.

In one implementation, the instructions, when executed by the controller, cause the device to maintain, when identifying a situation requiring termination of operation of the autonomous driving control device based on the information, the stopped state of the host vehicle based on the stopping deceleration for a specified time duration from a time point when the situation is identified, and terminate the operation of the autonomous driving control device after the specified time duration elapses.

According to another example of the present disclosure, a method for controlling autonomous driving includes identifying, by a controller, information on at least one of a host vehicle or a front vehicle, or any combination using a sensor, performing, by the controller, stopping control for the host vehicle with a first deceleration identified based on at least some of the information, and performing, by the controller, the stopping control for the host vehicle based on a deceleration greater than the first deceleration if at least one of an inter-vehicle distance or a travel speed, or any combination satisfies a specified condition while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include continuing, by the controller, to perform the stopping control based on a first required deceleration greater than the first deceleration if identifying that the inter-vehicle distance between the host vehicle and the front vehicle is smaller than a specified distance while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include gradually increasing, by the controller, a control amount for the stopping control from the first deceleration to the first required deceleration based on a first slope if identifying that the inter-vehicle distance is smaller than the specified distance.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include continuing, by the controller, to perform the stopping control based on a second required deceleration greater than the first deceleration if identifying that the travel speed of the host vehicle is lower than a specified speed while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include gradually increasing, by the controller, a control amount for the stopping control from the first deceleration to the second required deceleration based on a second slope if identifying that the travel speed is lower than the specified speed.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include gradually increasing, by the controller, a control amount for the stopping control from the first deceleration to a first required deceleration based on a first slope if identifying that the inter-vehicle distance between the host vehicle and the front vehicle is smaller than a specified distance while performing the stopping control, and gradually increasing, by the controller, the control amount from a first value to a second required deceleration greater than the first required deceleration based on a second slope greater than the first slope if identifying that the travel speed of the host vehicle is lower than a specified speed at a time point when the control amount has the first value while increasing the control amount based on the first slope.

In one implementation, the method may further include maintaining, by the controller, a stopped state of the host vehicle based on a stopping deceleration greater than the first deceleration when identifying that the host vehicle is stopped based on the travel speed of the host vehicle, maintaining, by the controller, when identifying a situation requiring termination of operation of an autonomous driving control device based on the information, the stopped state of the host vehicle based on the stopping deceleration for a specified time duration from a time point when the situation is identified, and terminating, by the controller, the operation of the autonomous driving control device after the specified time duration elapses.

According to another example of the present disclosure, a computer-readable recording medium contains a program for executing a method for controlling autonomous driving, and the method includes identifying, by a controller, information on at least one of a host vehicle or a front vehicle, or any combination using a sensor, performing, by the controller, stopping control for the host vehicle with a first deceleration identified based on at least some of the information, and performing, by the controller, the stopping control for the host vehicle based on a deceleration greater than the first deceleration if at least one of an inter-vehicle distance or a travel speed, or any combination satisfies a specified condition while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include continuing, by the controller, to perform the stopping control based on a first required deceleration greater than the first deceleration if identifying that the inter-vehicle distance between the host vehicle and the front vehicle is smaller than a specified distance while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include continuing, by the controller, to perform the stopping control based on a second required deceleration greater than the first deceleration if identifying that the travel speed of the host vehicle is lower than a specified speed while performing the stopping control.

In one implementation, the performing, by the controller, of the stopping control for the host vehicle based on the deceleration greater than the first deceleration if at least one of the inter-vehicle distance or the travel speed, or any combination satisfies the specified condition while performing the stopping control may further include gradually increasing, by the controller, a control amount for the stopping control from the first deceleration to a first required deceleration based on a first slope if identifying that the inter-vehicle distance between the host vehicle and the front vehicle is smaller than a specified distance while performing the stopping control, and gradually increasing, by the controller, the control amount from a first value to a second required deceleration greater than the first required deceleration based on a second slope greater than the first slope if identifying that the travel speed of the host vehicle is lower than a specified speed at a time point when the control amount has the first value while increasing the control amount based on the first slope.

In one implementation, the method may include maintaining, by the controller, a stopped state of the host vehicle based on a stopping deceleration greater than the first deceleration when identifying that the host vehicle is stopped based on the travel speed of the host vehicle, maintaining, by the controller, when identifying a situation requiring termination of operation of an autonomous driving control device based on the information, the stopped state of the host vehicle based on the stopping deceleration for a specified time duration from a time point when the situation is identified, and terminating, by the controller, the operation of the autonomous driving control device after the specified time duration elapses.

The description above is merely example of the technical idea of the present disclosure, and various modifications and changes may be made by those skilled in the art without departing from the essential characteristics of the present disclosure.

Therefore, the examples disclosed in the present disclosure are not intended to limit the technical idea of the present disclosure but to illustrate the present disclosure, and the scope of the technical idea of the present disclosure is not limited by the examples. The scope of the present disclosure should be construed as being covered by the scope of the appended claims, and all technical ideas falling within the scope of the claims should be construed as being included in the scope of the present disclosure.

Effects of the device and the method for controlling the autonomous driving according to the present disclosure are as follows.

According to at least one of the examples of the present disclosure, to perform the deceleration control and the stopping control for the host vehicle, the autonomous driving control device may control the host vehicle by dividing a control section for stopping into a general control section, a first section based on the first required deceleration, a second section based on the second required deceleration, and a complete stopping section, thereby providing a function of performing optimal stopping control for each section.

Additionally or alternatively, according to at least one of the examples of the present disclosure, if a change occurs in the travel situation, a relative relationship with the front vehicle, or the like while performing the stopping control, the stopping control may be performed by flexibly and smoothly changing the required deceleration, thereby minimizing the discomfort provided to the user during the stopping control.

In addition or alternative, according to at least one of the examples of the present disclosure, the autonomous driving control device may independently perform the stopping control without using a separate braking device, thereby reducing a production cost and a manufacturing cost required to produce a device for the stopping control.

In addition, various effects that are directly or indirectly identified through the present document may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device comprising:
a sensor;
a memory configured to store instructions; and
a controller operatively connected to the sensor and the memory,
wherein the instructions, when executed by the controller, cause the device to:
detect, based on the sensor, information associated with at least one of a first vehicle or a second vehicle;
determine at least one of:
whether a distance between the first vehicle and the second vehicle satisfies a distance condition, or
whether a travel speed of the first vehicle satisfies a speed condition; and
control the first vehicle:
based on at least some of the information and neither the distance condition nor the speed condition being satisfied, by causing a first deceleration; or
based on at least one of the distance condition or the speed condition being satisfied, by causing a second deceleration greater than the first deceleration.

2. The device of claim 1, wherein the instructions, when executed by the controller, cause the device to:
determine, based on the distance being smaller than a threshold distance, a third deceleration greater than the first deceleration; and
control the first vehicle by causing the third deceleration.

3. The device of claim 2, wherein the instructions, when executed by the controller, cause the device to:
control the first vehicle to change, over a time period, from the first deceleration to the third deceleration based on a slope.

4. The device of claim 1, wherein the instructions, when executed by the controller, cause the device to:
determine, based on the travel speed being lower than a threshold speed, a third deceleration greater than the first deceleration; and
control the first vehicle by causing the third deceleration.

5. The device of claim 4, wherein the instructions, when executed by the controller, cause the device to:
control the first vehicle to change, over a time period, from the first deceleration to the third deceleration based on a slope.

6. The device of claim 1, wherein the instructions, when executed by the controller, cause the device to:
control the first vehicle to change, over a time period, from the first deceleration to a third deceleration based on a first slope and the distance being smaller than a threshold distance; and
control the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

7. The device of claim 1, wherein the instructions, when executed by the controller, cause the device to:
maintain a stopped state of the first vehicle based on a stopping deceleration greater than the first deceleration and the first vehicle being stopped based on the travel speed.

8. The device of claim 7, wherein the instructions, when executed by the controller, cause the device to:
maintain the stopped state of the first vehicle for a time period starting from a time point at which a situation requiring termination of an autonomous driving control of the first vehicle is determined based on the information; and
terminate the autonomous driving control of the first vehicle after the time period elapses.

9. A method comprising:
detecting, by a controller and based on a sensor, information associated with at least one of a first vehicle or a second vehicle;
determining at least one of:
whether a distance between the first vehicle and the second vehicle satisfies a distance condition, or
whether a travel speed of the first vehicle satisfies a speed condition; and
controlling the first vehicle:
based on at least some of the information and based on neither the distance condition nor the speed condition being satisfied, by causing a first deceleration; or
based on at least one of the distance condition or the speed condition being satisfied, by causing a second deceleration greater than the first deceleration.

10. The method of claim 9, further comprising:
determining, based on the distance being smaller than a threshold distance, a third deceleration greater than the first deceleration; and
controlling the first vehicle by causing the third deceleration.

11. The method of claim 10, wherein the controlling the first vehicle comprises controlling the first vehicle to change, over a time period, from the first deceleration to the third deceleration based on a slope.

12. The method of claim 9, further comprising:
determining, based on the travel speed being lower than a threshold speed, a third deceleration greater than the first deceleration; and
controlling the first vehicle by causing the third deceleration.

13. The method of claim 12, wherein the controlling the first vehicle comprises controlling the first vehicle to change, over a time period, from the first deceleration to the third deceleration based on a slope.

14. The method of claim 9, wherein the controlling the first vehicle comprises:
controlling the first vehicle to change, over a time period, from the first deceleration to a third deceleration based on a first slope and the distance being smaller than a threshold distance; and
controlling the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

15. The method of claim 9, further comprising:
maintaining, by the controller, a stopped state of the first vehicle for a time period starting from a time point at which a situation requiring termination an autonomous driving control 4 the first vehicle is determined based on the information; and
terminating, by the controller, the autonomous driving control of the first vehicle after the time period elapses.

16. A non-transitory computer-readable recording medium storing a program, when executed, causes a controller to perform:
detecting, based on a sensor, information associated at least one of a first vehicle or a second vehicle;
determining at least one of:
whether a distance between the first vehicle and the second vehicle satisfies a distance condition, or
whether a travel speed of the first vehicle satisfies a speed condition; and
controlling the first vehicle:
based on at least some of the information and neither the distance condition nor the speed condition being satisfied, by causing a first deceleration; or
based on at least one of the distance condition or the speed condition being satisfied, by causing a second deceleration being greater than the first deceleration.

17. The non-transitory computer-readable recording medium of claim 16, wherein the program, when executed, causes the controller to perform:
determining, based on the distance being smaller than a threshold distance, a third deceleration greater than the first deceleration; and
controlling the first vehicle by causing the third deceleration.

18. The non-transitory computer-readable recording medium of claim 16, wherein the program, when executed, causes the controller to perform:
determining, based on the travel speed being lower than a threshold speed, a third deceleration greater than the first deceleration; and
controlling the first vehicle by causing the third deceleration.

19. The non-transitory computer-readable recording medium of claim 16, wherein the program, when executed, causes the controller to perform:
controlling the first vehicle to change, over a time period, from the first deceleration to a third deceleration based on a first slope and the distance being smaller than a threshold distance; and
controlling the first vehicle to change, over another time period, from a fourth deceleration to a fifth deceleration greater than the third deceleration based on a second slope greater than the first slope and the travel speed being lower than a threshold speed at a time point at which the first vehicle is controlled based on the fourth deceleration.

20. The non-transitory computer-readable recording medium of claim 16, wherein the program, when executed, causes the controller to perform:
maintaining a stopped state of the first vehicle for a time period starting from a time point at which a situation requiring termination an autonomous driving control of the first vehicle is determined based on the information; and
terminating the autonomous driving control of the first vehicle after the time period elapses.
